(19) United States
(12) Patent Application Publication
(10) Pub. No.: US 2026/0036816 A1
(43) Pub. Date: Feb. 5, 2026

(54) OPTICAL ELEMENT FOR AUGMENTED REALITY DEVICES

(71) Applicant: CORNING INCORPORATED, CORNING, NY (US)

(72) Inventor: Vladimir Nikolaevich Borisov, Helsinki (FI)

(21) Appl. No.: 19/272,147

(22) Filed: Jul. 17, 2025

Related U.S. Application Data
(60) Provisional application No. 63/677,065, filed on Jul. 30, 2024.

(51) Int. Cl. G02B 27/01

(52) U.S. Cl. CPC G02B 27/0172; G02B 2027/0118; G02B 2027/0123

(57) ABSTRACT

An optical element that includes an incoupling grating coupled to a lightguide and a support substrate, the incoupling grating being configured to guide light into the lightguide and the support substrate, and the following relationship being satisfied:

$${n}_{S} \geq 2 \cdot sin ( \frac{F O V}{2} ) + 1 ,$$

wherein n_{S} is the refractive index of the support substrate and POV is the field of view (degrees) of the optical element.

This application claims the benefit of priority to U.S. Provisional Patent Application No. 63/677,065 filed on Jul. 30, 2024, the content of which is relied upon and incorporated herein by reference in its entirety.

### FIELD

This description relates to optical elements for use in augmented reality devices. More particularly, this description relates to optical elements designed to improve transmittance of light within the optical element.

### BACKGROUND

An augmented reality device generates a virtual image and superimposes it on the viewing field of an observer. The virtual image includes information that supplements, enhances, or interprets objects in the viewing field. A common design for augmented reality devices is based on a combination of optical elements that include imaging optics, a lightguide, and light-coupling elements. The imaging optics generate a virtual image and direct it to an entrance light-coupling element. The entrance light-coupling element couples the imaging light into the lightguide whereupon it is transmitted within the lightguide to an exit light-coupling element that directs it to a specified location in the observer's field of view. The entrance and exit light-coupling elements are typically diffraction gratings and light is typically coupled into and out of the lightguide by diffraction.

Light provided by the imaging optics is typically non-collimated and approaches the entrance light-coupling element as a series of components that span a range of incidence angles. Upon diffraction into the lightguide by the entrance light-coupling element, the range of incidence angles produces components of diffracted light in the waveguide that transmit over a range of propagation angles to the exit light-coupling element. The mechanism of propagation within the lightguide is typically via total internal reflection (TIR), wherein the light is continuously reflected within the lightguide until it reaches the exit light-coupling element. Although TIR, by definition, is the complete reflection of light within the lightguide, in reality, some of the light is not reflected and instead is absorbed by the material of the lightguide. Such absorbance of the light by the lightguide results in decreased transmittance of the light to the exit light-coupling medium, which ultimately results in decreased quality of the image sent to the observer.

### SUMMARY

In the embodiments disclosed herein, optical elements are disclosed that increase the overall transmittance of the light propagated within the element to the exit light-coupling medium, thus resulting in increased image quality, including brightness and field of view.

According to a first aspect, an optical element is disclosed that comprises an incoupling grating coupled to a lightguide and a support substrate, the incoupling grating being configured to guide light into the lightguide and the support substrate, and the following relationship being satisfied:

$${n}_{S} \geq 2 \cdot sin ( \frac{F O V}{2} ) + 1 ,$$

wherein n_{S} is the refractive index of the support substrate and FOV is the field of view (degrees) of the optical element

According to a second aspect, an optical element is disclosed that comprises an incoupling grating coupled to a lightguide and a support substrate, the incoupling grating being configured to guide light into the lightguide and the support substrate, and the following relationship being satisfied:

$${n}_{S} \geq \frac{2 \cdot {n}_{L} \cdot a - b}{1 + b} + 1 ,$$

wherein n_{L} is the refractive index of the lightguide and a is the critical angle of the lightguide and is calculated using the following:

$$a = \frac{τ}{\sqrt{{τ}^{2} + 1}} , τ = \frac{s}{2 \cdot {t}_{L}} ,$$

wherein s is the pupil diameter of a projector that projects the light to the incoupling grating and t_{L} is the thickness of the lightguide 200, and wherein symbol b is calculated using the following:

$$b = \frac{{λ}_{+}}{{λ}_{-}} ,$$

wherein λ₊ is the largest wavelength of the light projected from the projector and A is the smallest wavelength of the light from projector.

According to a third aspect, a system is disclosed that comprises a projector and an optical element. The optical element comprising an incoupling grating, a lightguide, and a support substrate, the incoupling grating being coupled to the lightguide and the support substrate, the incoupling grating being configured to guide light into the lightguide and the support substrate, and the following relationship being satisfied

$${n}_{S} \geq \frac{2 \cdot {n}_{L} \cdot a - b}{1 + b} + 1 ,$$

wherein n_{L} is the refractive index of the lightguide and a is equal to sin (θ_{cr}) such that θ_{cr} is the critical angle of the lightguide and is calculated using the following:

$$a = \frac{τ}{\sqrt{{τ}^{2} + 1}} , τ = \frac{s}{2 \cdot {t}_{L}} ,$$

wherein s is the pupil diameter of the projector that projects the light to the incoupling grating and t_{L} is the thickness of the lightguide 200, and wherein symbol b is calculated using the following:

$$b = \frac{{λ}_{+}}{{λ}_{-}} ,$$

wherein λ₊ is the largest wavelength of the light projected from the projector and λ₋ is the smallest wavelength of the light from projector.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 is a schematic depiction of an optical element with light propagating within a lightguide;

FIG. 2 is a schematic depiction of input light incident on the optical element of FIG. 1 at an incidence angle α and a corresponding propagation angle θ of the light within the optical element;

FIG. 3A shows first, second, and third incident angles α₁, α₂, α₃ for blue wavelength light and the different propagation angles produced therefrom;

FIG. 3B shows blue, green, and red wavelength components of input light and the different propagation angles produced therefrom;

FIG. 4 is another schematic depiction of an optical element with light propagating within a lightguide;

FIG. 5 is a schematic depiction of an optical element with light propagating within a lightguide and a support substrate, according to the embodiments disclosed herein;

FIG. 6 is a plot of refractive index of the support substrate vs. refractive index of the lightguide of the optical element of FIG. 5, according to the embodiments disclosed herein;

FIG. 7 is a plot of refractive index of the support substrate vs. the field of view of the optical element of FIG. 5, according to the embodiments disclosed herein;

FIGS. 8A-8D are each a plot of the inherent transmittance of the lightguide material vs. the transmittance of the optical element for an exemplary example and for two comparison examples;

FIG. 8E is a plot of refractive index of the support substrate vs. refractive index of the lightguide of the exemplary and comparison examples of FIGS. 8A-8D;

FIG. 9 is a plot of refractive index of the lightguide vs. ratio of optical element absorbance to lightguide material absorbance of the exemplary and comparison examples of FIGS. 8A-8E; and

FIG. 10 is another schematic depiction of an optical element with light propagating within a lightguide and a support substrate, according to the embodiments disclosed herein.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

The present disclosure describes optical elements, comprised of a lightguide and a support substrate, that can be used in augmented reality and other light guiding devices. The optical elements include an entrance light-coupling element and an exit light-coupling element. Light-coupling elements include diffraction gratings such as an incoupling grating, which diffracts imaging light into the lightguide and the support substrate, and an outcoupling grating, which diffracts light out of the optical element. Gratings include 1D gratings, 2D gratings, holographic gratings, and may also include multiple layers of gratings. The incoupling and outcoupling gratings may be interfaced with or formed on a surface of the lightguide. In embodiments, the incoupling and outcoupling grating may be integrated into or onto a surface of the lightguide. Imaging light is directed to the incoupling grating and diffracted by the incoupling grating into the lightguide and the support substrate. The diffracted light propagates within the lightguide and the support substrate to the outcoupling grating and is diffracted by the outcoupling grating to the viewing field of a user of the device. The optical elements disclosed herein provide increased transmittance of light through the optical elements and to the user.

Disclosed are components (including materials, compounds, compositions, and method steps) that can be used for, in conjunction with, in preparation for, or as embodiments of the disclosed optical elements and methods for making optical elements. It is understood that when combinations or subsets, interactions of the components are disclosed, each component individually and each combination of two or more components is also contemplated and disclosed herein even if not explicitly stated. If, for example, if a combination of components A, B, and C is disclosed, then each of A, B, and C is individually disclosed as is each of the combinations A-B, B-C, A-C, and A-B-C. Similarly, if components D, E, and F are individually disclosed, then each combination D-E, E-F, D-F, and D-E-F is also disclosed. This concept applies to all aspects of this disclosure including, but not limited to, components corresponding to materials, compounds, compositions, and steps in methods.

In this specification and in the claims which follow, reference will be made to a number of terms which shall be defined to have the following meanings:

“Include,” “includes,” or like terms means encompassing but not limited to, that is, inclusive and not exclusive.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but are otherwise joined to each other through one or more intervening materials. Elements in contact may be rigidly or non-rigidly joined. Contacting refers to placing two elements in direct or indirect contact. Elements in direct (indirect) contact may be said to directly (indirectly) contact each other.

The indefinite article “a” or “an” and its corresponding definite article “the” as used herein means at least one, or one or more, unless specified otherwise.

The term “refractive index” refers to the refractive index at a wavelength of 587.56 nm (n_{d}) for optical materials with an Abbe number greater than 25 (moderately-dispersive optical materials). Furthermore, the term “refractive index” refers to the refractive index at a wavelength of 650 nm for optical materials with an Abbe number less than or equal to 25 (highly-dispersive optical materials)

The Abbe number, which can also be referred to as the V-number, is a measure of a material's dispersion (change of refractive index versus wavelength), with high Abbe numbers indicating low dispersion. The Abbe number of a material is calculated using the following Eq. (1):

$$V = \frac{nd - 1}{nf - nc} \qquad ( 1 )$$

where V is the Abbe number, nc is the refractive index of the material at a wavelength of 656.3 nm, nd is the refractive index of the material at a wavelength of 587.56 nm, and nf is the refractive index of the material at a wavelength of 486.1 nm.

The term “blue wavelength light” refers to light having a wavelength within a range from 430 nm to 495 nm.

The term “green wavelength light” refers to light having a wavelength within a range from 495 nm to 570.

The term “red wavelength light” refers to light having a wavelength within a range from 620 nm to 750 nm.

The claims as set forth below are incorporated into and constitute part of this Detailed Description.

The construction and arrangement of the elements of the present disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

Reference will now be made in detail to illustrative embodiments of the present description.

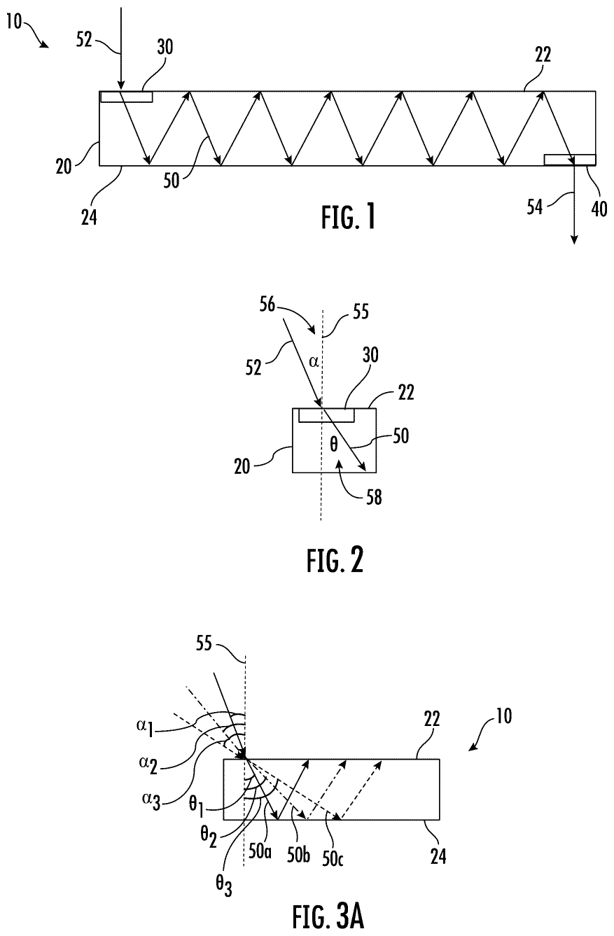

FIG. 1 illustrates a conventional optical element 10 for use in an augmented reality device. Optical element 10 includes lightguide 20, incoupling grating 30 (entrance light-coupling element) for guiding light into lightguide 20, and outcoupling grating 40 (exit light-coupling element) for guiding light out of lightguide 20. In particular, input light 52 is directed into lightguide 20 and output light 54 is directed out of lightguide 20 and to a viewer, for example to the eye of a user wearing a virtual reality device. As shown in FIG. 1, lightguide 20 may guide light 50 by TIR between surfaces 22 and 24 of the lightguide.

Input light 52 may be comprised of multiple light components having different wavelengths (e.g., blue, green, and red wavelength light). The multiple light components may be incident on incoupling grating 30 over a range of incidence angles α (e.g., α₁, α₂, α₃). It is noted that both the wavelength of the light (e.g., blue, green, or red wavelength light) and the incidence angle α of the light affect the propagation of the light within a lightguide. In particular, due to the different incidence angles α₁, α₂, α₃ and due to the different wavelengths of each of the blue, green, and red wavelength light, light 50 is transmitted through lightguide 20 with different propagation angles θ under TIR. Therefore, the multiple light components, with different incidence angles α, are transmitted through lightguide 20 over a range of propagation angles θ. FIG. 2 shows a component of input light 52 approaching incoupling grating 30 on first surface 22 of lightguide 20 at an incidence angle α (depicted at 56) relative to normal 55 of first surface 22. Input light 52 is diffracted by incoupling grating 30 to form a component of guided light 50 having an angle of propagation θ (depicted at 58) that propagates through lightguide 20 under TIR.

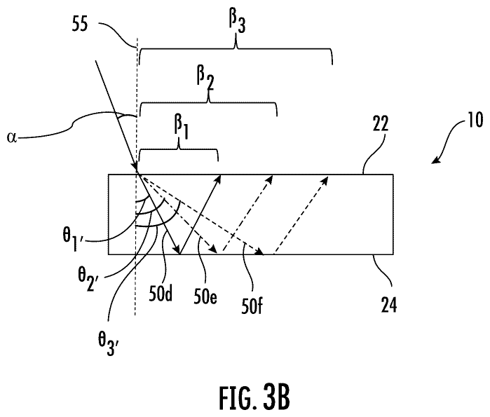

FIG. 3A shows first, second, and third incidence angles α₁, α₂, α₃ for a blue wavelength light component of input light 52 and the different propagation angles produced therefrom. As shown in FIG. 3A, blue wavelength light 50a with a first incidence angle α₁ propagates within the lightguide with a first propagation angle θ₁, blue wavelength light 50b with a second incidence angle α₂ propagates within the lightguide with a second propagation angle θ₂, and blue wavelength light 50c with a third incidence angle α₃ propagates within the lightguide with a third propagation angle θ₃. A larger incidence angle α corresponds to a large propagation angle θ.

FIG. 3B similarly shows different propagation angles θ₁, θ₂, θ₃; but for different wavelengths of light. As shown in FIG. 3B, blue wavelength light 50d propagates within the lightguide with a first propagation angle θ_{1′}, green wavelength light 50e propagates within the lightguide with a second propagation angle θ_{2′}, and red wavelength light 50f propagates within the lightguide with a third propagation angle θ_{3′}. The blue wavelength light 50d, green wavelength light 50c, and red wavelength light 50f are incident upon the lightguide at the same incidence angle α. Accordingly, FIG. 3A shows the effect on the propagation angle of the transmitted light due to the different incidence angles while FIG. 3B shows the effect on the propagation of the transmitted light due to the different wavelengths of light.

The relationship between the wavelength of light, incidence angle α, and the propagation angle θ is shown by Eqs. (2) and (3), where Eq. (2) can be rewritten as Eq. (3):

$$sin ( α ) + \frac{λ}{Λ} = n sin ( θ ) \qquad ( 2 )$$

$$θ = arcsin ( \frac{sin ( α ) + \frac{λ}{Λ}}{n} ) \qquad ( 3 )$$

wherein α is the incidence angle, as discussed above, θ is the propagation angle of the propagating light within the lightguide, as discussed above, A is the wavelength of the propagating light, A is a surface period of the incoupling grating (e.g., a surface period of incoupling grating 30), and n is the refractive index of the material through which the light propagates (e.g., the material of lightguide 20). As shown by Eqs. (2) and (3) above, a larger incidence angle α corresponds to a larger propagation angle θ. Furthermore, a larger wavelength of light λ corresponds to a larger propagation angle θ.

As shown in FIG. 3B, the blue wavelength light 50d propagates with a relatively smaller propagation angle θ_{1′}, thus producing a relatively smaller reflection period Bi between incoupling grating 30 and outcoupling grating 40, whereas the red wavelength light 50f propagates with a relatively larger propagation angle θ₃, thus producing a relatively larger reflection period β₃ between incoupling grating 30 and outcoupling grating 40. Furthermore, green wavelength light 50c propagates with a larger propagation angle θ₂; than that of the blue wavelength light 50d but smaller than that of the red wavelength light 50f, thus producing a reflection period β₂ such that β₁<β₂<β₃. The relatively smaller reflection period β₁ of the blue wavelength light 50d means that the blue wavelength light reflects between surfaces 22 and 24 of lightguide 20 more times than the light of either the green or red wavelengths 50e, 50f (which have the relatively larger reflection periods β₂, β₃). Because the blue wavelength light 50d reflects the most between surfaces 22 and 24, the blue wavelength light 50d has the largest propagation distance within lightguide 20. Therefore, due to its relatively smaller reflection period β₁, the blue wavelength light 50d has a larger propagation distance within lightguide 20 than either the green or red wavelength light 50e, 50f.

As the light propagates within lightguide 20, some of the light is absorbed by the material of lightguide 20, even though the light is propagating under TIR. As discussed further below, the absorption of the light is especially pronounced in the blue wavelength light 50a, as this light has the largest propagation distance within lightguide 20 (due to its smaller reflection period β₁) and the fact that the relatively shorter wavelengths of the blue light tend to be less transmissive near the fundamental absorption wavelength region of an optical material.

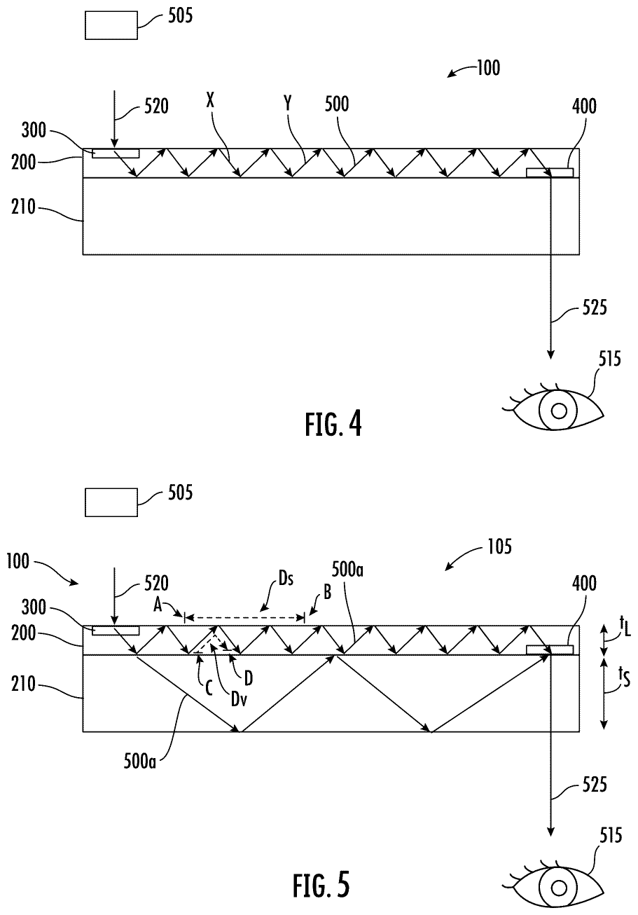

FIG. 4 shows an optical element 100 for use in, for example, an augmented reality device. Optical element 100 includes lightguide 200 coupled to a support substrate 210, incoupling grating 300 (entrance light-coupling element) for guiding input light 520 into lightguide 200, and outcoupling grating 400 (exit light-coupling element) for guiding output light 525 out of lightguide 200. Input light 520 may be projected from a projector 505, and output light 525 may be directed to the eye of a user 515.

Lightguide 200 is comprised of a material with a higher refractive index than that of support substrate 210. Therefore, light 500 propagates within lightguide 200 under TIR such that the light reflects between surfaces 220 and 240 of lightguide 200. But, as described above, in reality, some of the light 500 propagating under TIR within lightguide 200 is absorbed by lightguide 200. More specifically, as the light propagates along lightguide 200, more and more of the light is absorbed by lightguide 200 so that less light propagates within lightguide 200 at, for example, point Y than at point X. Due to the absorption of light, less light is transmitted along the length of lightguide 200 to outcoupling grating 400. Therefore, less light is transmitted to the user 515, resulting in decreased transmittance quality. The loss of transmitted light is especially pronounced for blue wavelength light, as it has the largest propagation distance within lightguide 200 (due to its smaller reflection period β₁). Therefore, the blue wavelength light travels a further distance when propagating within lightguide 200 (as compared to red and green wavelength light), which provides a longer distance over which the blue wavelength light is absorbed by lightguide 200 and, thus, relatively more absorption of the blue wavelength light. The loss of transmitted light is also pronounced for blue wavelength light due the fact that the relatively shorter wavelengths of the blue light tend to be less transmissive near the fundamental absorption wavelength region of an optical material.

An object of the present disclosure is to reduce the loss of transmitted light as the light propagates within lightguide 200. Therefore, an object of the present disclosure is to reduce the amount of light absorbed within lightguide 200. In particular, an object of the present disclosure is to reduce the amount of light traveling in lightguide 200 and increase the amount of light traveling in support substrate 210. Such reduces the amount of light absorbed so that more light is transmitted to the viewer, which results in a better image quality. In order to optimize the amount of light traveling within lightguide 200 and within support substrate 210, the refractive indices of these layers are optimized, as discussed further below.

FIG. 5 shows an optical element 100 according to embodiments of the present disclosure and with similar components to that of FIG. 4. Similar to FIG. 4, optical element 100 comprises lightguide 200 coupled to a support substrate 210, incoupling grating 300 (entrance light-coupling element) for guiding input light 520 into lightguide 200 and support substrate 210, and outcoupling grating 400 (exit light-coupling element) for guiding output light 525 out of lightguide 200 and support substrate 210. Input light 520 may be projected from a projector 505, and output light 525 may be directed to the eye of a user 515. Optical element 100 may be used in, for example, an augmented reality device. Reference numeral 105 in FIG. 5 refers to the entire system that comprises optical element 100 along with projector 505. Although optical element 100 of FIG. 5 is similar to that of FIG. 4, optical element of FIG. 5 optimizes the refractive indices of lightguide 200 and support substrate 210 so that the light 500 propagates within both lightguide 200 and support substrate 210. In particular, optical element of FIG. 5 optimizes the refractive indices of lightguide 200 and support substrate 210 so that all of the angular components of the blue wavelength light propagate within both lightguide 200 and support substrate 210. As discussed further below, such reduces the amount of light absorbed and increases the image quality of the output light.

Lightguide 200 may be planar or curved. Furthermore, lightguide 200 may be relatively thinner than support substrate 210. In embodiments, lightguide 200 may have a thickness t_{L} of about 0.50 mm or less, or about 0.40 mm or less, or about 0.30 mm or less, or about 0.20 mm or less, or about 0.15 mm or less, or about 0.10 mm or less, or about 0.05 mm or less. Additionally or alternatively, lightguide 200 may have a thickness of about 0.05 mm or greater, or about 0.10 mm or greater, or about 0.15 mm or greater, or about 0.20 mm or greater, or about 0.30 mm or greater, or about 0.40 mm or greater, or about 0.50 mm or greater. In embodiments, the thickness t_{L} is from about 0.05 mm to about 0.50 mm, or about 0.10 mm to about 0.40 mm, or about 0.15 mm to about 0.30 mm, or about 0.20 mm to about 0.30 mm.

Support substrate 210 may have a thickness t_{S} of about 1.00 mm or less, or about 0.90 mm or less, or about 0.80 mm or less, or about 0.70 mm or less, or about 0.60 mm or less, or about 0.50 mm or less, or about 0.40 mm or less, or about 0.30 mm or less, or about 0.20 mm or less. Additionally or alternatively, support substrate 210 may have a thickness t_{S} of about 0.20 mm or greater, or about 0.30 mm or greater, or about 0.40 mm or greater, or about 0.50 mm or greater, or about 0.60 mm or greater, or about 0.70 mm or greater, or about 0.80 mm or greater, or about 0.90 mm or greater, or about 1.00 mm or greater. In embodiments, the thickness t_{S} is from about 0.20 mm to about 1.00 mm, or about 0.30 mm to about 0.90 mm, or about 0.40 mm to about 0.80 mm, or about 0.50 mm to about 0.70 mm, or about 0.60 mm to about 0.70 mm.

Lightguide 200 may be comprised of a glass material such as, for example, phosphate and/or silicate glass, including modified forms thereof (e.g., borosilicates, borophosphates, aluminosilicates, aluminophosphates, glass doped with alkali or alkaline earth metals, etc.). The glass material of lightguide 200 may include one or more high-index modifiers to increase the refractive index of the glass. Exemplary high-index modifiers include, for example, TiO₂, Nb₂O₅, Bi₂O₃, WO₃, and rare earth oxides (e.g., La₂O₃, Y₂O₃, Gd₂O₃). Representative compositions of glasses for lightguide 200 are provided in U.S. Pat. Nos. 11,802,073; 11,472,731; 11,479,499; and 11,485,676; and also in U.S. Published patents application Nos. 20220073409, 20220073410, 20230339803, 20230339801, and 20230303426, the disclosures of which are incorporated by reference herein. In some embodiments, lightguide 200 is comprised of a solid-state material, or a crystalline material, or a semiconductor material such as, for example, silicon carbide, or zirconium dioxide, or titanium dioxide, or germanium disulfide, or crystalline carbon, or mixtures thereof.

Support substrate 210 may be comprised of, for example, a low-density material or a high-density material. Exemplary materials of support substrate 210 comprise glass, glass-ceramic, and polymers. Glass materials comprise, for example, fused silica, soda lime glass, Gorilla® glass (available from Corning Incorporated), phosphate and/or silicate glass, including modified forms thereof (e.g., borosilicates, borophosphates, aluminosilicates, aluminophosphates, glass doped with alkali or alkaline earth metals, etc.). Representative polymers comprise, for example, polyacrylates, polyimides, polyamides, polycarbonates, polyethylene, and cyclic olefins. In some embodiments, support substrate 210 may include one or more high-index modifiers to increase the refractive index of the material. Exemplary high-index modifiers include, for example, TiO₂, Nb₂O₅, Bi₂O₃, WO₃, and rare earth oxides (e.g., La₂O₃, Y₂O₃, Gd₂O₃). Representative compositions of glasses for support substrate 210 are provided in U.S. Pat. Nos. 11,802,073; 11,472,731; 11,479,499; and 11,485,676; and also in U.S. Published patents application Nos. 20220073409, 20220073410, 20230339803, 20230339801, and 20230303426, the disclosures of which are incorporated by reference herein.

The refractive index of lightguide 200 may about 1.90 or greater, or about 2.00 or greater, or about 2.10 or greater, or about 2.20 or greater, or about 2.30 or greater, or about 2.40 or greater, or about 2.50 or greater, or about 2.60 or greater, or about 2.70 or greater, or about 2.80 or greater, or about 2.90 or greater, or about 3.00 or greater. Additionally or alternatively, the refractive index of lightguide 200 may be about 3.00 or less, or about 2.90 or less, or about 2.80 or less, or about 2.70 or less, or about 2.60 or less, or about 2.50 or less, or about 2.40 or less, or about 2.30 or less, or about 2.20 or less, or about 2.10 or less, or about 2.00 or less, or about 1.90. In embodiments, the refractive index of lightguide 200 is in a range from about 1.90 to about 3.00, or about 2.00 to about 2.90, or about 2.10 to about 2.80, or about 2.20 to about 2.70, or about 2.30 to about 2.60, or about 2.40 to about 2.50, or any combination of ranges encompassing these endpoints. The refractive index of lightguide 200 may be higher than the refractive index of support substrate 210.

Support substrate 210 may have a lower refractive index than that of lightguide 200. The refractive index of support substrate 210 may about 2.50 or less, or about 2.40 or less, or about 2.30 or less, or about 2.20 or less, or about 2.10 or less, or about 2.00 or less, or about 1.90 or less, or about 1.80 or less, or about 1.70 or less, or about 1.60 or less, or about 1.50 or less, or about 1.45 or less. Additionally or alternatively, the refractive index of support substrate 210 is about 1.45 or greater, or about 1.50 or greater, or about 1.60 or greater, or about 1.70 or greater, or about 1.80 or greater, or about 1.90 or greater, or about 2.00 or greater, or about 2.10 or greater, or about 2.20 or greater, or about 2.30 or greater, or about 2.40 or greater, or about 2.50 or greater. In embodiments, the refractive index of support substrate 210 may be in a range from about 1.45 to about 2.50, or about 1.50 to about 2.40, or about 1.60 to about 2.30, or about 1.70 to about 2.20, or about 1.80 to about 2.10, or about 1.90 to about 2.00, or any combination of ranges encompassing these endpoints.

But, as further discussed below, the refractive indices of lightguide 200 and support substrate 210 are optimized in order to increase the overall transmittance of light within optical element 100.

FIG. 5, in particular, shows blue wavelength light 500a propagating in both lightguide 200 and support substrate 210. Lightguide 200 has a higher refractive index than that of support substrate 210. Due to the lower refractive index of support substrate 210, less light is absorbed when propagating within support substrate 210 than within lightguide 200. As is known in the art, decreasing the refractive index of an optical material shifts the fundamental absorption wavelength curve of that optical material, resulting in relatively lower optical absorption of that material. This concept is also discussed in Lucarini, Valerio, et al. Kramers-Kronig relations in optical materials research, Vol. 110, Springer Science & Business Media, 2005, which is incorporated herein by reference. Because the material of support substrate 210 absorbs less propagating light than the material of lightguide 200, it is beneficial to propagate more light within support substrate 210 than within lightguide 200. In the embodiments disclosed herein, light is transmitted under TIR in both lightguide 200 and support substrate 210 to increase the amount of light transmitted to outcoupling grating 400 (and, thus, to the user). In particular, in the embodiments disclosed herein, blue wavelength light is transmitted under TIR in both lightguide 200 and support substate 210 to increase the amount of blue wavelength light transmitted to outcoupling grating 400 (and, thus, to the user). Because the light is transmitted in support substrate 210 (in addition to lightguide 200), the overall absorption of the propagating light decreases.

As disclosed herein, the transmittance of the light propagating within optical element 100 may be referred to herein with reference to a surface propagation distance or with reference to a volume propagation distance. Surface propagation distance refers to the distance along the optical element parallel to a centerline axis of the optical element. Stated another way, surface propagation distance is the distance along a surface of the optical element in a direction of the propagating light. FIG. 5 shows an exemplary surface propagation distance Ds that spans the distance from point A to point B on lightguide 200. This distance between point A and point B may vary in size from only a portion of lightguide 200 to the entire distance between incoupling grating 300 and outcoupling grating 400. The transmittance of light with reference to the surface propagation distance refers to the ratio of propagating light between points A and B. Thus an optical element with low transmittance of light would have less light transmitted at point B than at point A (due to the absorption of light by the optical element).

Volume propagation distance refers to the distance along the optical pathway of the light. FIG. 5 shows an exemplary volume propagation distance Dv that spans the distance from point C to point D within lightguide 200. As shown in FIG. 5, the volume propagation distance Dv follows the path of the propagating light 500. This distance between point C and point D may vary in size from only a portion of lightguide 200 to the entire distance between incoupling grating 300 and outcoupling grating 400. The transmittance of light with reference to the volume propagation distance refers to the ratio of propagating light between points C and D. Thus an optical element with low transmittance of light would have less light transmitted at point D than at point C (due to the absorption of the light by the optical element).

The inventor of the present disclosure discovered that the refractive indices of lightguide 200 and support substrate 210 must be within specific ranges relative to each other in order to increase the amount of light traveling with support substrate 210 (and, thus, increase the overall transmittance of the light). In particular, in the embodiments disclosed herein, the refractive indices of lightguide 200 and support substrate 210 are within specific ranges relative to each in order to increase the amount of light traveling within support substrate 210 and, in particular, increase the amount of blue wavelength light traveling within support substrate 210. When the refractive indices are within the ranges disclosed herein, the light propagates in both lightguide 200 and support substrate 210, thus increasing the overall transmittance of the light. In particular, when the refractive indices are within the ranges disclosed herein, all of the blue wavelength light propagates in both lightguide 200 and support substrate 210, thus increasing the overall transmittance of the light. When the refractive indices are outside of the ranges disclosed herein, at least one angular component of the light only propagates in lightguide 200, thus decreasing the overall transmittance of the light. In particular, when the refractive indices are outside of the ranges disclosed herein, at least one angular component of the blue wavelength light only propagates in lightguide 200, thus decreasing the overall transmittance of the light.

In the embodiments disclosed herein, the refractive index of lightguide 200 is relatively high to increase the field of view of lightguide 200, as is known in the art. Furthermore, the refractive index of support substrate 210 is lower than the refractive index of lightguide 200 and within a specific range relative to the refractive index of lightguide 200 so that all angular components of the blue wavelength light propagate in both of these elements, as discussed above. Furthermore, the refractive index of each lightguide 200 and support substrate 210 are optimized so that the blue wavelength travels within each of lightguide and support substrate under TIR.

In the embodiments disclosed herein, the refractive indices of lightguide 200 and support substrate 210 are set so that the following Eq. (4) is satisfied:

$${n}_{S} \geq \frac{2 \cdot {n}_{L} \cdot a - b}{1 + b} + 1 \qquad ( 4 )$$

wherein n_{S} is the refractive index of support substrate 210, n_{L} is the refractive index of lightguide 200, and a is calculated using the following Eqs. (5) and (6):

$$a = \frac{τ}{\sqrt{{τ}^{2} + 1}} \qquad ( 5 )$$

$$τ = \frac{s}{2 \cdot {t}_{L}} \qquad ( 6 )$$

wherein s is the pupil diameter of projector 505 and t_{L} is the thickness of lightguide 200, as discussed above.

The symbol b in equation (4) is calculated using the following Eq. (7):

$$b = \frac{{λ}_{+}}{{λ}_{-}} \qquad ( 7 )$$

wherein λ₊ is the largest wavelength of the light projected from projector 505 and λ₋ is the smallest wavelength of the light projected from projector 505. In embodiments, λ₊ corresponds to red wavelength light and λ₋ corresponds to blue wavelength light.

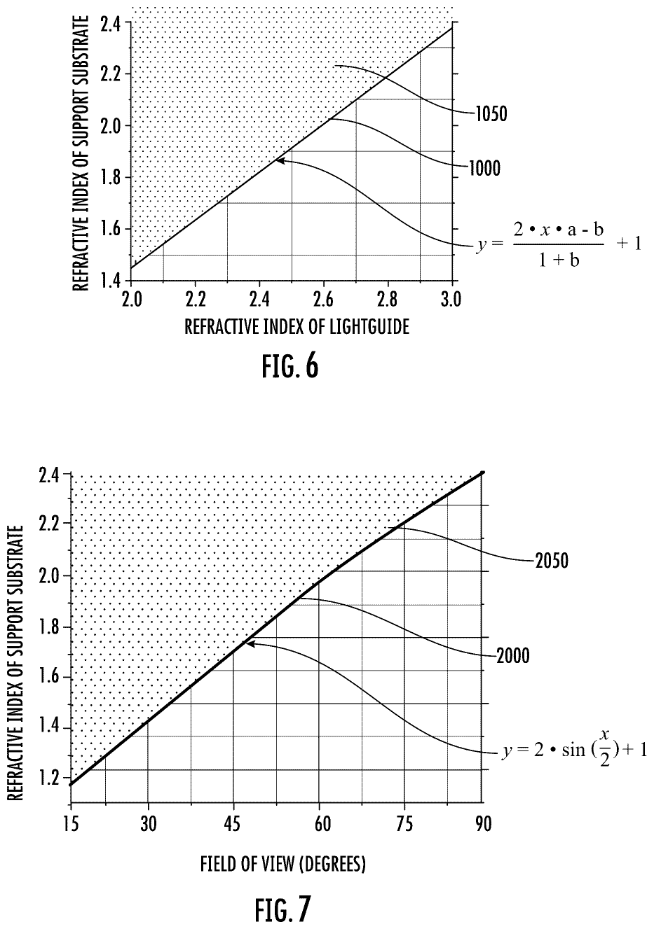

FIG. 6 shows a plot 1000 of Eq. (4) as a function of the refractive index (n_{L}) of lightguide 200 vs. the refractive index (n_{S}) of support substrate 210. In the embodiments disclosed herein, the refractive indices of lightguide 200 and of support substrate 210 are optimized so that angular components of light 500, in particular all angular components of blue wavelength light, propagate within both lightguide 200 and support substrate 210 when the refractive indices of these layers are equal to or greater than plot 1000. Therefore, the refractive indices of lightguide 200 and of support substrate 210 are optimized, according to the embodiments disclosed herein, when the refractive indices are within area 1050 of FIG. 6. More specifically, when the refractive indices are within area 1050 of FIG. 6, the refractive index of lightguide 200 is sufficiently high to enable a large field of view of lightguide 200, thus providing a better quality image to the user. Furthermore, when the refractive indices are within area 1050 of FIG. 6, the refractive index of the support substrate 210 is sufficiently low to reduce the optical absorption of support substrate 210 while still allowing the light to propagate within support substrate 210 under TIR.

By optimizing the refractive indices of lightguide 200 and support substrate 210 to meet the relationship of Eq. (4), all of the angular components of the blue wavelength light 500a are able to propagate in both lightguide 200 and support substrate 210.

Eq. (8) below shows the relationship between the refractive index (n_{S}) of support substrate 210 and the field of view of optical element 100 for blue wavelength light, according to the embodiments disclosed herein:

$${n}_{S} \geq 2 \cdot sin ( \frac{FOV}{2} ) + 1 \qquad ( 8 )$$

wherein FOV is the field of view (degrees) of optical element 100 for blue wavelength light.

FIG. 7 shows a plot 2000 of Eq. (8) as a function of the refractive index (n_{S}) of support substrate 210 vs. the field of view of optical element 100. In the embodiments disclosed herein, the refractive index of support substrate 210 and the field of view of optical element 100 (which is dependent on the refractive indices of both lightguide 200 and support substrate 210) are optimized so that the refractive index of support substrate 210 and the field of view of optical element 100 are equal to or greater than plot 2000. Therefore, the refractive indices of lightguide 200 and of support substrate 210 are optimized, according to the embodiments disclosed herein, when the refractive index and field of view are within area 2050 of FIG. 7. More specifically, when the refractive index and field of view are within area 2050 of FIG. 7, the refractive index of lightguide 200 is sufficiently high to enable a large field of view of lightguide 200, thus providing a better quality image to the user. Furthermore, when the refractive index and field of view are within area 2050 of FIG. 7, the refractive index of the support substrate 210 is sufficiently low to reduce the optical absorption of support substrate 210 while still allowing the light to propagate within support substrate 210 under TIR.

By optimizing the refractive indices of lightguide 200 and support substrate 210 to meet the relationship of Eq. (8), all of the angular components of the blue wavelength light 500a arc able to propagate in both lightguide 200 and support substrate 210.

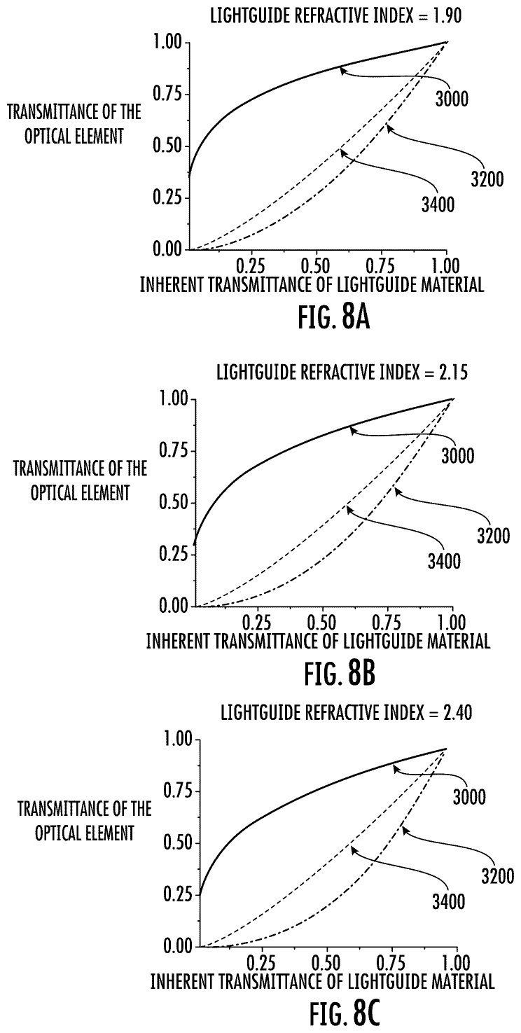

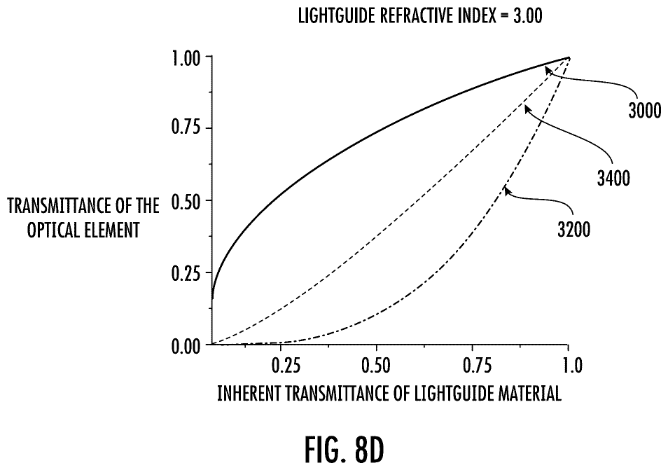

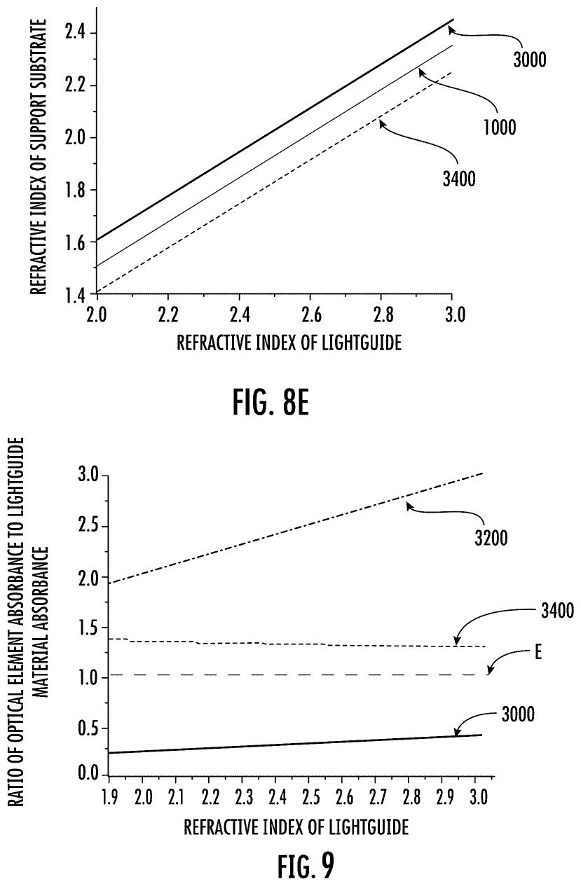

FIGS. 8A through 8D include examples showing that the embodiments disclosed herein provide higher transmittance of propagating light. In particular, FIGS. 8A through 8D show the relatively higher transmittance of the light propagating in an optical element according to the embodiments disclosed herein (Exemplary Optical Element 3000) and the relatively lower transmittance of light propagating in two comparison optical elements that are outside of the embodiments disclosed herein (Comparison Optical Elements 3200 and 3400). The transmittance of the exemplary and comparison optical elements are plotted in FIGS. 8A through 8D for four different refractive index values (i.e., 1.90, 2.15, 2.40, and 3.00) of the lightguide of the optical elements. Furthermore, in each of these plots, the refractive index of the support substrate is adjusted based upon the refractive index of the lightguide in order to provide the disclosed optimization within areas 1050 and 2050 of FIGS. 6 and 7, respectively, of Exemplary Optical Element 3000.

Exemplary Optical Element 3000 has the configuration shown in FIG. 5 and comprises a lightguide with a thickness of 0.1 mm and a support substrate with a thickness of 0.5 mm. The lightguide of Exemplary Optical Element 3000 is formed of an alkali borosilicate glass and the support substrate of Exemplary Optical Element 3000 is formed of a low density glass. In the plot of FIG. 8A, the support substrate of Exemplary Optical Element 3000 has a refractive index of 1.50 and the lightguide of Exemplary Optical Element 3000 has a refractive of 1.90. In the plot of FIG. 8B, the support substrate of Exemplary Optical Element 3000 has a refractive index of 1.72 and the lightguide of Exemplary Optical Element 3000 has a refractive of 2.15. In the plot of FIG. 8C, the support substrate of Exemplary Optical Element 3000 has a refractive index of 1.93 and the lightguide of Exemplary Optical Element 3000 has a refractive of 2.40. And, in the plot of FIG. 8D the support substrate of Exemplary Optical Element 3000 has a refractive index of 2.43 and the lightguide of Exemplary Optical Element 3000 has a refractive of 3.00. Thus, Exemplary Optical Element 3000 meets the relationship of Eqs. (4) and (8) for all four plots.

Comparison Optical Element 3200 is a conventional optical element with a single lightguide layer, such as that shown in FIG. 1. Therefore, Comparison Optical Element 3200 does not meet the requirements of Eqs. (4) and (8). The lightguide of Comparison Optical Element 3200 has a thickness of 0.6 mm and is formed of an alkali borosilicate glass. In the plot of FIG. 8A, the lightguide of Comparison Element 3200 has a refractive index of 1.90. In the plot of FIG. 8B, the lightguide of Comparison Element 3200 has a refractive index of 2.15. In the plot of FIG. 8C, the lightguide of Comparison Element 3200 has a refractive index of 2.40. And, in the plot of FIG. 8D, the lightguide of Comparison Element 3200 has a refractive index of 3.00.

Comparison Optical Element 3400 has the configuration shown in FIG. 4 and comprises a lightguide with a thickness of 0.1 mm and a support substrate with a thickness of 0.6 mm. The lightguide of Comparison Optical Element 3400 is formed of an alkali borosilicate glass and the support substrate of Comparison Optical Element 3400 is formed of a low density glass. In the plot of FIG. 8A, the support substrate of Comparison Optical Element 3400 has a refractive index of 1.40 and the lightguide of Comparison Optical Element 3400 has a refractive of 1.90. In the plot of FIG. 8B, the support substrate of Comparison Optical Element 3400 has a refractive index of 1.62 and the lightguide of Comparison Optical Element 3400 has a refractive of 2.15. In the plot of FIG. 8C, the support substrate of Comparison Optical Element 3400 has a refractive index of 1.83 and the lightguide of Comparison Optical Element 3400 has a refractive of 2.40. And, in the plot of FIG. 8D, the support substrate of Comparison Optical Element 3400 has a refractive index of 2.33 and the lightguide of Comparison Optical Element 3400 has a refractive of 3.00. Thus, Comparison Optical Element 3400 does not meet the requirements of Eqs. (4) and (8).

FIG. 8E further highlights the differences between Exemplary Optical Element 3000 and Comparison Optical Element 3400, wherein Exemplary Optical Element is above plot 1000 (as also shown in FIG. 6) and Comparison Optical Element 3400 is below plot 1000 over the rang of refractive index values shown. Thus, Exemplary Optical Element 3000 is within area 1050 of FIG. 6 while Comparison Optical Element 3400 is below area 1050. FIG. 8E shows that Exemplary Optical Element 3000 comprises a lightguide and support substrate with optimized refractive indices within the disclosed embodiments. In contrast, Comparison Optical Element 3400 comprises a lightguide and support substrate with refractive indices that are outside of the disclosed embodiments.

It is noted that Exemplary Optical Element 3000, Comparison Optical Element 3200, and Comparison Optical Element 3400 all comprise the same diffractive elements including the same incoupling and outcoupling gratings. Therefore, the difference in transmittance of light between Exemplary Optical Element 3000, Comparison Optical Element 3200, and Comparison Optical Element 3400 is due to the optimized refractive indices, as disclosed in the embodiments herein.

With reference again to FIGS. 8A through 8D, each of these plots show the inherent transmittance of the lightguide material vs. the transmittance of the optical element as normalized values. The inherent transmittance of the lightguide material is plotted on the x-axis to show how the inherent light absorbing properties of the lightguide material and, thus, the contribution of the lightguide material to the reduced transmittance of the propagating light. Furthermore, in FIGS. 8A through 8D, the inherent transmittance of the lightguide material is calculated per 1 cm volume propagation distance of the transmitted light. The transmittance of the optical element is plotted on the y-axis to show the amount of light transmitted (and not absorbed) as it travels along the length of the optical element. The transmittance of the optical element, in FIGS. 8A through 8D, is calculated per 1 cm surface propagation distance of the transmitted light. FIGS. 8A, 8B, 8C, and 8D each show the transmittance of light within the respective optical elements while accounting for the inherent absorption properties of the material of the lightguide.

As shown in FIGS. 8A through 8D, Exemplary Optical Element 3000 has much higher transmittance of propagating light for each of the lightguide refractive index values of 1.90, 2.15, 2.40, and 3.00. Thus, FIGS. 8A through 8D show the optimized refractive index values disclosed herein for the lightguide and support substrate advantageously provide increased transmittance of the propagating light and, thus, reduced absorption of the propagating light.

FIG. 9 shows a plot of the ratio of the absorbance of the optical element to the absorbance of the lightguide material vs. the refractive index of the lightguide for each of Exemplary Optical Element 3000, Comparison Optical Element 3200, and Comparison Optical Element 3400. In particular, the y-axis of FIG. 9 shows the ratio (aᵣ) of the absorbance of the optical element (aₑ) to absorbance of the lightguide material (aₘ) such that aᵣ is equal to aₑ/aₘ. The absorbance of the optical element (de) is calculated using Eq. 9:

$${a}_{e} = \frac{ln ( \frac{{I}_{B}}{{I}_{A}} )}{{D}_{s}} \qquad ( 9 )$$

where I_{B} is the intensity of the light at point B of the lightguide (as shown in FIG. 5), I_{A} is the intensity of the light at point A of the lightguide (as shown in FIG. 5), and D_{S} is the surface propagation distance between points A and B, as discussed above. Thus, I_{B}/I_{A} is the transmittance of the optical element per surface propagation distance D_{S} (with reference to FIGS. 8A-8C).

The absorbance of the lightguide material (aₘ) is calculated using Eq. 10:

$${a}_{m} = \frac{ln ( \frac{{I}_{D}}{{I}_{C}} )}{{D}_{v}} \qquad ( 10 )$$

where I_{D} is the intensity of the light at point D of the lightguide (as shown in FIG. 5), I_{C} is the intensity of the light at point C of the lightguide (as shown in FIG. 5), and Dᵥ is the volume propagation distance between points C and D, as discussed above. Thus, I_{D}/I_{C}, is th transmittance of the optical element per volume propagation distance Dy (with reference to FIGS. 8A-8C).

The surface propagation distance D_{S} is chosen to be the same as the volume propagation distance Dᵥ so that they are cancelled out when calculating the ratio (aᵣ), as shown in Eq. 11:

$${a}_{r} = {a}_{e} / {a}_{m} = \frac{ln ( \frac{{I}_{B}}{{I}_{A}} )}{ln ( \frac{{I}_{D}}{{I}_{C}} )} = \frac{ln ( {T}_{s} )}{ln ( {T}_{v} )} \qquad ( 11 )$$

where T_{S} is the transmittance of the optical element per 1 cm surface propagation distance (as referenced above on the y-axis in FIGS. 8A-8D) and Ty is the inherent transmittance of the lightguide material per 1 cm volume propagation distance (as referenced above on the x-axis in FIGS. 8A-8C).

Thus, FIG. 9 show the dependance of the ratio of optical element absorbance to lightguide material absorbance (aₑ/aₘ) vs. the lightguide refractive index for Exemplary Optical Element 3000 as well as for Comparison Optical Elements 3200 and 3400. The dashed horizontal line E on FIG. 9 represents when the ratio aₑ/aₘ is equal to 1.0, meaning that the optical element absorbs light at the same rate as the lightguide material given equal corresponding surface propagation and volume propagation distances. The plot of the Exemplary Optical Element 3000 in FIG. 9 is below line E, thus showing that Exemplary Optical Element 3000 advantageously absorbs less light that the lightguide material itself. In fact, the plot of Exemplary Optical Element 3000 in FIG. 9 has an average value of about 0.25, which means that Exemplary Optical Element 3000 absorbs about 4 times less light than the lightguide material itself. In contrast, Comparison Optical Element 3200 is above line E with an average value of about 2.1, which means that Comparison Optical Element 3200 absorbs about 2.1 times more light than the lightguide material itself. Furthermore, Comparison Optical Element 3200 absorbs about 8.4 times more light than Exemplary Optical Element 3000. Additionally, Comparison Optical Element 3400 is also above line E with an average value of about 1.3, which means that Comparison Optical Element 3400 absorbs about 1.3 times more light than the lightguide material itself. Furthermore, Comparison Optical Element 3400 absorbs about 5.2 times more light than Exemplary Optical Element 3000.

In the embodiments disclosed herein and with reference again to FIG. 5, optical element 100 may have a relatively low density so that optical element 100 may be used in, for example, augmented reality devices. In embodiments, the density of lightguide 200 may be about 3.0 g/cm³ or greater, or about 3.5 g/cm³ or greater, or about 4.0 g/cm³ or greater, or about 4.5 g/cm³ or greater, or about 5.0 g/cm³ or greater, or about 5.5 g/cm³ or greater, or about 6.0 g/cm³ or greater, or about 7.0 g/cm³ or greater. In embodiments, the density of lightguide 200 may be in a range from about 3.0 g/cm³ to about 7.0 g/cm³, or about 3.0 g/cm³ to about 6.0 g/cm³, or about 3.5 g/cm³ to about 5.5 g/cm³, or about 4.0 g/cm³ to about 5.0 g/cm³, or about 4.5 g/cm³ to about 5.0 g/cm³, or any combination of ranges encompassing these endpoints.

The density of support substrate 210 may be about 5.0 g/cm³ or less, or about 4.5 g/cm³ or less, or about 4.0 g/cm³ or less, or about 3.5 g/cm³ or less, or about 3.0 g/cm³ or less, or about 2.5 g/cm³ or less, or about 2.0 g/cm³ or less, or about 1.5 g/cm³ or less, or about 1.0 g/cm³ or less, or about 0.5 g/cm³ or less. In embodiments, the density of support substrate 210 may be in range from about 0.5 g/cm³ to about 5.0 g/cm³, or about 1.0 g/cm³ to about 4.5 g/cm³, or about 1.5 g/cm³ to about 4.0 g/cm³, or about 2.0 g/cm³ to about 3.5 g/cm³, or about 2.5 g/cm³ to about 3.0 g/cm³, or any combination of ranges encompassing these endpoints. In some embodiments, support substrate 210 has the same (or substantially the same) density as lightguide 200. In other embodiments support substrate 210 has a lower or higher density than the density of lightguide 200.

Support substrate 210, in some embodiments disclosed herein, comprises a higher thickness and a lower density than that of lightguide 210 in order to provide an element optical with reduced weight, which is ideal for augmented reality applications.

The combination of lightguide 200 and support substrate 210, according to the embodiments disclosed herein, provides beneficial features for augmented reality applications. More specifically, lightguide 200 provides a thin layer with a high refractive index that facilitates good image quality of the guided light with a high field of view while also reducing overall weight of the device. Support substrate 210 provides mechanical support to lightguide 200, also allowing the overall weight of the device to be reduced. Furthermore, support substrate 210 may be comprised of less expensive materials, thus reducing the overall cost of production.

In some embodiments, one or more additional layers may be disposed between lightguide 200 and support substrate 210. These additional layers may help to filter the light propagating under TIR within support substrate 210, which increases the brightness uniformity across the field of view of support substrate 210. For example, the additional layers filter out light with very large propagation angles θ so that this light does not propagate in support substrate 210. If light with such large propagation angles θ does propagate in support substrate 210, it may not be outcoupled out of support substrate 210 due to its large propagation angle, which negatively affects brightness uniformity across the field of view of support substrate 210. The one or more additional layers may have a refractive index less than the refractive index of support substrate 210. In embodiments, the one or more additional layers may have a refractive index of about 2.45 or less, or about 2.40 or less, or about 2.35 or less, or about 2.30 or less, or about 2.25 or less, or about 2.20 or less, or about 2.15 or less, or about 2.10 or less, or about 2.05 or less, or about 2.00 or less, or about 1.95 or less, or about 1.90 or less, or about 1.85 or less, or about 1.80 or less, or about 1.75 or less, or about 1.70 or less, 1.65 or less, or about 1.60 or less, or about 1.55 or less, or about 1.50 or less, or about 1.45 or less, or about 1.40 or less, or about 1.35 or less, or about 1.30 or less. In embodiments, the refractive index of support substrate 210 may be in a range from about 1.30 to about 2.45, or about 1.35 to about 2.40, or about 1.40 to about 2.35, or about 1.45 to about 2.30, or about 1.50 to about 2.25, or about 1.55 to about 2.20, or about 1.60 to about 2.15, or about 1.65 to about 2.10, or about 1.70 to about 2.05, or about 1.75 to about 2.00, or about 1.80 to about 1.95, or about 1.85 to about 1.90, or any combination of ranges encompassing these endpoints.

The one or more additional layers may have a cumulative thickness of about 20.0 microns or less, or about 17.5 microns or less, or about 15.0 microns or less, or about 12.5 microns or less, or about 10.0 microns or less, or about 7.5 microns or less, or about 5.0 microns or less, or about 3.0 microns or less, or about 2.5 microns or less, or about 2.0 microns or less, or about 1.5 microns or less, or about 1.0 micros or less, or about 0.5 microns or less, or about 0.2 microns or less. Additionally or alternatively, the one or more additional layers may have a cumulative thickness of about 0.2 microns or greater, or about 0.5 microns or greater, or about 1.0 microns or greater, or about 1.5 microns or greater, or about 2.0 microns or greater, or about 2.5 microns or greater, or about 3.0 microns or greater, or about 5.0 microns or greater, or about 7.5 microns or greater, or about 10.0 microns or greater, or about 12.5 microns or greater, or about 15.0 microns or greater, or about 17.5 microns or greater or about 20.0 microns or greater. In embodiments, the cumulative thickness may be in a range from about 0.2 microns to about 20.0 microns, or about 0.5 microns to about 17.5 microns, or about 1.0 microns to about 15.0 microns, or about 1.5 microns to about 12.5 microns, or about 2.0 microns to about 10.0 microns, or about 2.5 microns to about 7.5 microns, or about 3.0 microns to about 5.0 microns, or any range encompassing these endpoints.

The material of the one or more additional layers may comprise, for example, organic materials, inorganic materials, or organic-inorganic composites. In some exemplary embodiments, the one or more additional layers comprise polycarbonate, polymethyl methacrylate (PMMA), Poly(vinyl alcohol) (PVA), Polyvinyl chloride (PVC), and/or a metal oxide such as, for example, zirconium oxide. In embodiments, the one or more additional layers may comprise one or more layers of a material with a relatively low refractive index and one or more materials with a relatively high refractive index. The layers may be disposed on lightguide 200 and/or on support substrate 210 by any well-known deposition means such as, for example, spin-coating, deposition coating, or injection printing.

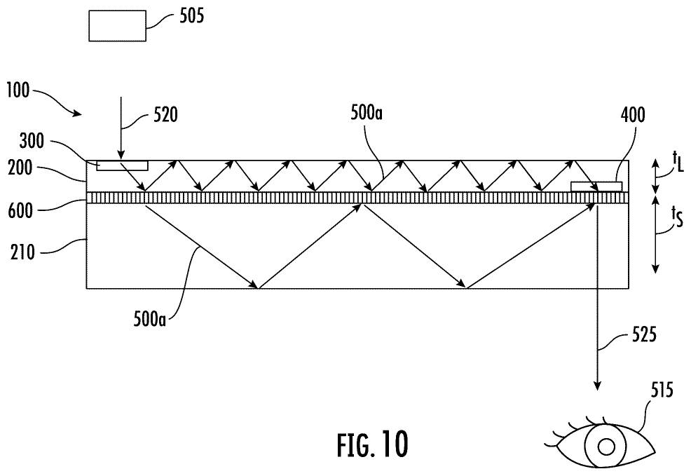

FIG. 10 shows an exemplary embodiment of an additional layer 600 disposed between lightguide 200 and support substrate 210 to help improve the brightness uniformity of a virtual image across the field of view within support substrate 210. In this exemplary example, additional layer 600 is comprised of one layer of an optical polymer comprised of PVC and has a refractive index of 1.55 and a thickness of about 10 microns. Furthermore, in the exemplary example, lightguide 200 has a refractive index of 2.00 and a thickness of 0.1 mm, and support substrate 210 has a refractive index of 1.60 and a thickness of 0.5.

According to a first aspect, an optical element comprising an incoupling grating coupled to a lightguide and a support substrate, the incoupling grating being configured to guide light into the lightguide and the support substrate, and the following relationship being satisfied:

$${n}_{S} \geq 2 \cdot sin ( \frac{FOV}{2} ) + 1 ,$$

wherein n_{S} is the refractive index of the support substrate and FOV is the field of view (degrees) of the optical element.

According to a second aspect, the optical element of the first aspect, wherein the light is guided under total internal reflection within the lightguide.

According to a third aspect, the optical element of the first or second aspect, wherein the light is guided under total internal reflection within the support substrate.

According to a fourth aspect, the optical element of any one of the first through third aspects, wherein the light comprises blue wavelength light.

According to a fifth aspect, the optical element of any one of the first through fourth aspects, wherein a refractive index of the lightguide is greater than the refractive index of the support substrate.

According to a sixth aspect, the optical element of any one of the first through fifth aspects, wherein a refractive index of the lightguide is within a range from about 1.90 to about 3.00.

According to a seventh aspect, the optical element of any one of the first through sixth aspects, wherein a refractive index of the support substrate is within a range from about 1.45 to about 2.50.

According to an eighth aspect, the optical element of any one of the first through seventh aspects, wherein a refractive index of the lightguide is within a range from about 1.90 to about 3.00 and a refractive index of the support substrate is within a range from about 1.45 to about 2.50.

According to a ninth aspect, the optical element of any one of the first through eight aspects, wherein a thickness of the support substrate is greater than a thickness of the lightguide.

According to a tenth aspect, the optical element of the ninth aspect, wherein the thickness of the lightguide is about 0.50 mm or less.

According to an eleventh aspect, the optical element of the tenth aspect, wherein the thickness of the lightguide is about 0.20 mm or less.

According to a twelfth aspect, the optical element of any one of the first through eleventh aspects, further comprising an additional element between the lightguide and the support substrate.

According to a thirteenth aspect, the optical element of the twelfth aspect, wherein the additional layers comprises a thickness of about 20 microns or less.

According to a fourteenth aspect, the optical element of any one of the first through thirteenth aspects, wherein the following relationship is satisfied:

$${n}_{S} \geq \frac{2 \cdot {n}_{L} \cdot a - b}{1 + b} + 1 ,$$

wherein n_{L} is the refractive index of the lightguide and a is the critical angle of the lightguide and is calculated using the following:

$$a = \frac{τ}{\sqrt{{τ}^{2} + 1}} , τ = \frac{s}{2 \cdot {t}_{L}} ,$$

wherein s is the pupil diameter of a projector that projects the light to the incoupling grating and t_{L} is the thickness of the lightguide 200, and wherein symbol b is calculated using the following:

$$b = \frac{{λ}_{+}}{{λ}_{-}} ,$$

wherein λ₊ is the largest wavelength of the light projected from the projector and λ₋ is the smallest wavelength of the light from projector.

According to a fifteenth aspect, an optical element comprising an incoupling grating coupled to a lightguide and a support substrate, the incoupling grating being configured to guide light into the lightguide and the support substrate, and the following relationship being satisfied:

$${n}_{S} \geq \frac{2 \cdot {n}_{L} \cdot a - b}{1 + b} + 1 ,$$

wherein n_{L} is the refractive index of the lightguide and a is the critical angle of the lightguide and is calculated using the following:

$$a = \frac{τ}{\sqrt{{τ}^{2} + 1}} , τ = \frac{s}{2 \cdot {t}_{L}} ,$$

wherein s is the pupil diameter of a projector that projects the light to the incoupling grating and t_{L} is the thickness of the lightguide 200, and wherein symbol b is calculated using the following:

$$b = \frac{{λ}_{+}}{{λ}_{-}} ,$$

wherein λ₊ is the largest wavelength of the light projected from the projector and A is the smallest wavelength of the light from projector.

According to a sixteenth aspect, the optical element of the fifteenth aspect, wherein the light is guided under total internal reflection within the lightguide.

According to a seventeenth aspect, the optical element of the fifteenth or sixteenth aspect, wherein the light is guided under total internal reflection within the support substrate.

According to an eighteenth aspect, the optical element of any one of the fifteenth through seventeenth aspects, wherein the light comprises blue wavelength light.

According to a nineteenth aspect, the optical element of any one of the fifteenth through eighteenth aspects, wherein a refractive index of the lightguide is greater than the refractive index of the support substrate.

According to a twentieth aspect, the optical element of any one of the fifteenth through nineteenth aspects, wherein a refractive index of the lightguide is within a range from about 1.90 to about 3.00.

According to a twenty-first aspect, the optical element of any one of the fifteenth through twentieth aspects, wherein a refractive index of the support substrate is within a range from about 1.45 to about 2.50.

According to a twenty-second aspect, the optical element of any one of the fifteenth through twenty-first aspect, wherein a refractive index of the lightguide is within a range from about 1.90 to about 3.00 and a refractive index of the support substrate is within a range from about 1.45 to about 2.50.

According to a twenty-third aspect, the optical element of any one of the fifteenth through twenty-second aspects, wherein a thickness of the support substrate is greater than a thickness of the lightguide.

According to a twenty-fourth aspect, the optical element of the twenty-third aspect, wherein the thickness of the lightguide is about 0.50 mm or less.

According to a twenty-fifth aspect, the optical element of the twenty-fourth aspect, wherein the thickness of the lightguide is about 0.20 mm or less.

According to a twenty-sixth aspect, the optical element of any one of the fifteenth through twenty-fifth aspects, further comprising an additional element between the lightguide and the support substrate.

According to a twenty-seventh aspect, the optical element of the twenty-sixth aspect, wherein the additional layers comprises a thickness of about 20 microns or less.

According to a twenty-eighth aspect, a system comprising a projector and an optical element comprising an incoupling grating, a lightguide, and a support substrate, the incoupling grating being coupled to the lightguide and the support substrate, the incoupling grating being configured to guide light into the lightguide and the support substrate, and the following relationship being satisfied:

$${n}_{S} \geq \frac{2 \cdot {n}_{L} \cdot a - b}{1 + b} + 1 ,$$

wherein n_{L} is the refractive index of the lightguide and a is equal to sin (θ_{cr}) such that θₑᵣ is the critical angle of the lightguide and is calculated using the following:

$$a = \frac{τ}{\sqrt{{τ}^{2} + 1}} , τ = \frac{s}{2 \cdot {t}_{L}} ,$$

wherein s is the pupil diameter of the projector that projects the light to the incoupling grating and t_{L} is the thickness of the lightguide 200, and wherein symbol b is calculated using the following:

$$b = \frac{{λ}_{+}}{{λ}_{-}} ,$$

wherein λ₊ is the largest wavelength of the light projected from the projector and A is the smallest wavelength of the light from projector.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or description that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations, and variations of the disclosed embodiments that incorporate the spirit and substance of the illustrated embodiments may occur to persons skilled in the art, the description should be construed to include everything within the scope of the appended claims and their equivalents.

What is claimed is:

1. An optical element comprising:
an incoupling grating coupled to a lightguide and a support substrate,
the incoupling grating being configured to guide light into the lightguide and the support substrate, and
the following relationship being satisfied:
$${n}_{S} \geq 2 \cdot sin ( \frac{FOV}{2} ) + 1 ,$$
wherein n_{S} is the refractive index of the support substrate and FOV is the field of view (degrees) of the optical element.

2. The optical element of claim 1, wherein the light is guided under total internal reflection within the lightguide.

3. The optical element of claim 1, wherein the light is guided under total internal reflection within the support substrate.

4. The optical element of claim 1, wherein the light comprises blue wavelength light.

5. The optical element of claim 1, wherein a refractive index of the lightguide is greater than the refractive index of the support substrate.

6. The optical element of claim 1, wherein a refractive index of the lightguide is within a range from about 1.90 to about 3.00.

7. The optical element of claim 1, wherein a refractive index of the support substrate is within a range from about 1.45 to about 2.50.

8. The optical element of claim 1, wherein a refractive index of the lightguide is within a range from about 1.90 to about 3.00 and a refractive index of the support substrate is within a range from about 1.45 to about 2.50.

9. The optical element of claim 1, wherein a thickness of the support substrate is greater than a thickness of the lightguide.

10. The optical element of claim 9, wherein the thickness of the lightguide is about 0.50 mm or less.

11. The optical element of claim 10, wherein the thickness of the lightguide is about 0.20 mm or less.

12. The optical element of claim 1, further comprising an additional element between the lightguide and the support substrate.

13. The optical element of claim 12, wherein the additional layers comprises a thickness of about 20 microns or less.

14. The optical element of claim 1 wherein the following relationship is satisfied:
$${n}_{S} \geq \frac{2 \cdot {n}_{L} \cdot a - b}{1 + b} + 1$$
wherein n_{L} is the refractive index of the lightguide and a is the critical angle of the lightguide and is calculated using the following:
$$a = \frac{τ}{\sqrt{{τ}^{2} + 1}} ,$$
$$τ = \frac{s}{2 \cdot {t}_{L}} ,$$
wherein s is the pupil diameter of a projector that projects the light to the incoupling grating and t_{L} is the thickness of the lightguide 200, and
wherein symbol b is calculated using the following:
$$b = \frac{{λ}_{+}}{{λ}_{-}} ,$$
wherein λ₊ is the largest wavelength of the light projected from the projector and λ₋ is the smallest wavelength of the light from projector.

15. An optical element comprising:
an incoupling grating coupled to a lightguide and a support substrate,
the incoupling grating being configured to guide light into the lightguide and the support substrate, and
the following relationship being satisfied:
$${n}_{S} \geq \frac{2 \cdot {n}_{L} \cdot a - b}{1 + b} + 1$$
wherein n_{L} is the refractive index of the lightguide and a is the critical angle of the lightguide and is calculated using the following:
$$a = \frac{τ}{\sqrt{{τ}^{2} + 1}} ,$$
$$τ = \frac{s}{2 \cdot {t}_{L}} ,$$
wherein s is the pupil diameter of a projector that projects the light to the incoupling grating and t_{L} is the thickness of the lightguide 200, and
wherein symbol b is calculated using the following:
$$b = \frac{{λ}_{+}}{{λ}_{-}} ,$$
wherein λ₊ is the largest wavelength of the light projected from the projector and λ₋ is the smallest wavelength of the light from projector.

16. The optical element of claim 15, wherein the light is guided under total internal reflection within the lightguide.

17. The optical element of claim 15, wherein the light is guided under total internal reflection within the support substrate.

18. The optical element of claim 15, wherein the light comprises blue wavelength light.

19. The optical element of claim 15, wherein a refractive index of the lightguide is greater than the refractive index of the support substrate.

20. A system comprising:
a projector; and
an optical element comprising an incoupling grating, a lightguide, and a support substrate,
the incoupling grating being coupled to the lightguide and the support substrate,
the incoupling grating being configured to guide light into the lightguide and the support substrate, and
the following relationship being satisfied:
$${n}_{S} \geq \frac{2 \cdot {n}_{L} \cdot a - b}{1 + b} + 1$$
wherein n_{L} is the refractive index of the lightguide and a is equal to sin (θ_{cr}) such that θ_{cr} is the critical angle of the lightguide and is calculated using the following:
$$a = \frac{τ}{\sqrt{{τ}^{2} + 1}} ,$$
$$τ = \frac{s}{2 \cdot {t}_{L}} ,$$
wherein s is the pupil diameter of the projector that projects the light to the incoupling grating and t_{L} is the thickness of the lightguide 200, and
wherein symbol b is calculated using the following:
$$b = \frac{{λ}_{+}}{{λ}_{-}} ,$$
wherein λ₊ is the largest wavelength of the light projected from the projector and λ₋ is the smallest wavelength of the light from projector.
